(19) United States
(12) Patent Application Publication
(10) Pub. No.: US 2012/0038527 A1
(43) Pub. Date: Feb. 16, 2012

(54) GLASS ANTENNA

(76) Inventor: Kosuke Tanaka, Tokyo (JP)

(21) Appl. No.: 13/138,934

(22) PCT Filed: Apr. 27, 2010
(86) PCT No.: PCT/JP2010/057434

§ 371 Date: Oct. 27, 2011

(30) Foreign Application Priority Data
Apr. 28, 2009 (JP) 2009-109966

(51) Int. Cl. H01Q 1/32

(52) U.S. Cl. 343/713

(57) ABSTRACT

Disclosed is a glass antenna wherein two antennas, which are formed on a glass surface and have different receiving frequency bands, are integrated. In the glass antenna (30), the glass surface (10) includes a first antenna pattern (31), which is composed of one perpendicular conductive body (310) and a plurality of horizontal conductive bodies (311-316) orthogonally intersecting the perpendicular conductive body, and a second antenna pattern (32), which has a receiving frequency band different from that of the first antenna pattern and is composed of one horizontal conductive body (320) capacitively coupled with the first antenna pattern. One discretionary horizontal conductive body among the plurality of horizontal conductive bodies of the first antenna pattern is connected to a power feed point (20) by means of a connecting conductive line (40). Signals received by the first antenna pattern or the second antenna pattern are amplified by means of a shared amplifier (50).

### TECHNICAL FIELD

The present invention relates to a glass antenna in which an antenna pattern and a power feed point for feeding power to the antenna pattern are formed on a glass surface.

### BACKGROUND ART

A glass antenna on which an antenna conductor has been formed on a rear window of a vehicle has excellent external appearance because there is no protrusion on the design surface in comparison with a conventional rod antenna. Glass antennas are widely used because, among other reasons, there is no concern about damage and wind noise is not produced.

Glass antennas in which an AM/FM shared antenna has been mounted are becoming more widely used. For example, Patent Literature 1 discloses a glass antenna in which a high-frequency choke coil is inserted between a ground and a bus bar that constitute an antifogging heater, and this defogging electric heater can also be used as an antenna.

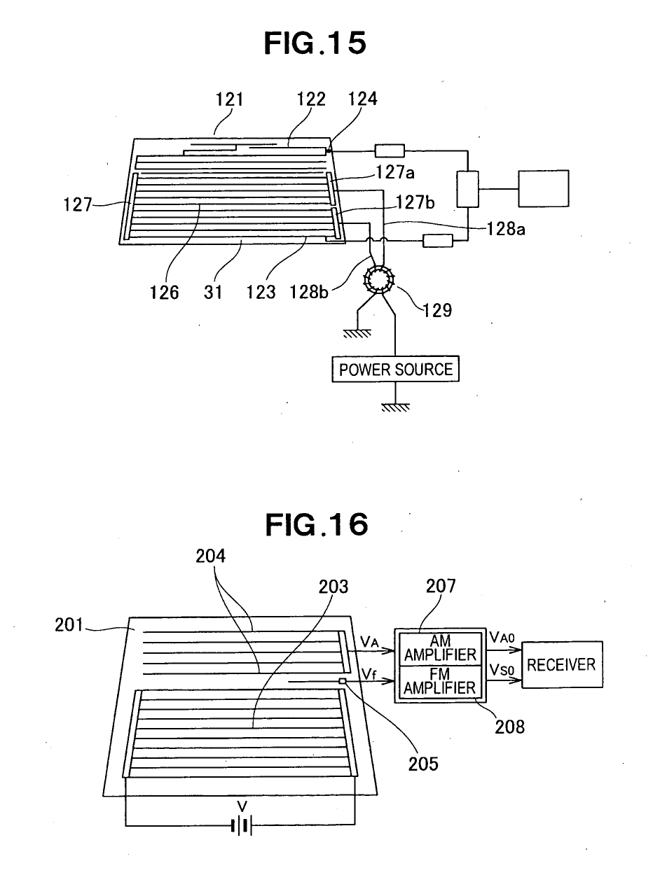

The glass antenna disclosed in Patent Literature 1 is described below with reference to FIG. 15 hereof.

In FIG. 15, a main antenna 122, a slave antenna 123, and a power feed point 124 of the main antenna 122 are formed on a glass antenna 121. One of the bus bars 127 of the defogging electric heater 126 constituting the slave antenna 123 is divided into two. Power source leads 128a, 128b are connected to bus bars 127a, 127b. A high-frequency choke coil 129 is furthermore inserted between ground and the power source leads 128a, 128b, and the defogging electric heater 126 is insulated from high frequencies by the high-frequency choke coil. The configuration accordingly allows the electromagnetic waves induced in the defogging electric heater 126 to flow to a radio receiver without leaking out.

However, according to the glass antenna disclosed in Patent Literature 1, the main antenna 122 is a complicated AM/FM shared antenna pattern and therefore requires a significant amount of time to adjust. An expensive high-frequency choke coil 129 that can handle large currents for noise removal is required in order to use the defogging electric heater 126 as an AM receiver antenna as well. There is a drawback in that installation space is required for a high-frequency choke coil.

In order to solve this drawback, Patent Literature 2 discloses a glass antenna device of a vehicle window in which the AM antenna pattern and the FM antenna pattern are formed independent of each other, and an expensive high-frequency choke coil for large currents is made unnecessary.

The glass antenna device disclosed in Patent Literature 1 is described below with reference to FIG. 16.

In FIG. 16, a glass antenna device 201 for a vehicle window is composed of an AM antenna 204 for receiving AM band signals, the AM antenna 204 being composed of a plurality of horizontal antenna patterns in the upper part of a choke coil-less antifogging heater 203; and an FM antenna 205 for receiving FM band signals, the FM antenna 205 being composed of a single horizontal antenna pattern disposed between the choke coil-less antifogging heater 203 and the AM antenna 204.

In accordance with the art disclosed in Patent Literature 2 described above, an expensive high-frequency choke coil for large currents is made unnecessary, and the AM antenna 204 and FM antenna 205 are formed independent of each other, making adjustment a relatively simple matter. In particular, the FM antenna 205 is composed of a single simple horizontal antenna pattern, and the configuration is easy to use because adaptation is possible by merely modifying the length in the case that the destination has changed and the operation frequency band has changed.

However, in accordance with the glass antenna device disclosed in Patent Literature 2, connection terminals must be provided to the AM antenna 204 and the FM antenna 205 because the AM antenna 204 and the FM antenna 205 are independent of each other. Also, input lines must be provided in accompaniment therewith to an AM amplifier 207 and an FM amplifier 208. Connection work using the input lines is also required in the assembly step of the vehicle manufacturer. Therefore, there is a need to reduce the number of components and to reduce the labor required for assembly and adjustment.

### PRIOR ART LITERATURE

### Patent Literature

Patent Literature 1: Japanese Patent Application Laid-Open Publication No. S57-188102
Patent Literature 2: Japanese Domestic Republication No. 2003-500870

### SUMMARY OF INVENTION

### Technical Problem

An object of the present invention is to provide a glass antenna in which the number of components is reduced and the labor for assembly and adjustment is reduced.

### Solution to Problem

In accordance with a first aspect of the present invention, a glass antenna is provided in which an antenna pattern and a power feed point for feeding power to the antenna pattern are formed on a glass surface, the glass antenna characterized in comprising: a first antenna pattern having at least one vertical conductor and a plurality of horizontal conductors made orthogonal to the vertical conductor; a second antenna pattern comprised of a single, mainly horizontal conductor capacitively coupled with the first antenna pattern, the second antenna pattern having one end connected to the power feed point and having a receiving frequency band different from that of the first antenna; a connecting conductive line for connecting a single discretionary line among the plurality of horizontal conductors of the first antenna pattern to the power feed point; and a shared amplifier for amplifying a signal received by the first antenna pattern and the second antenna pattern, the shared amplifier being connected to the power feed point.

Preferably, the horizontal conductors of the first antenna pattern extend 325 to 350 mm from the vertical conductor.

Preferably, the horizontal conductor of the second antenna pattern is disposed in an upper part of a first line of a topmost part among the plurality of horizontal conductors of the first antenna pattern.

Preferably, the horizontal conductor of the second antenna pattern is disposed between the first line of the topmost part and a second line therebelow among the plurality of horizontal conductors of the first antenna pattern

Preferably, the power feed point is a lateral-edge power feed point formed on the lateral-edge corner part of the glass surface; and the connecting conductive line is connected to the horizontal conductor formed in a bottommost part of the first antenna pattern.

Preferably, the power feed point is a lateral-edge power feed point formed on the lateral-edge corner part of the glass surface; and the connecting conductive line is connected to the third horizontal conductor from the bottom among the horizontal conductors of the first antenna pattern.

Preferably, the power feed point is a lateral-edge power feed point formed on the lateral-edge corner part of the glass surface; and the connecting conductive line has a length of 400 mm or less and is connected in a position 45 mm or more away from the second antenna pattern.

Preferably, the power feed point is an upper-edge power feed point formed on the upper edge and substantially center part of the glass surface; and the connecting conductive line is connected to a topmost first line of the first antenna pattern positioned on the side opposite from the side on which the horizontal conductor of the second antenna pattern is disposed, using the line perpendicular to the glass surface through which the power feed point passes as a boundary.

Preferably provided is a glass antenna comprising: an antifogging heater formed in the lower part of the first antenna pattern; and a receiving-sensitivity adjustment element for adjusting the receiving sensitivity of the first antenna pattern and the second antenna pattern, the receiving-sensitivity adjustment element being connected to at least one of the bus bar and the heater line included in the antifogging heater.

Preferably, a single horizontal conductor for forming a third antenna pattern having a different power feed point than that of the first and second antenna patterns is disposed on the side opposite from the side on which the horizontal conductor forming the second antenna pattern is disposed, using the vertical conductor of the first antenna pattern as a boundary; and a diversity antenna is formed by the first and second antenna patterns and the single horizontal conductor for forming the third antenna pattern.

Preferably, a diversity antenna is formed by: an antifogging heater formed in the lower part of the first antenna pattern; the first and second antenna patterns; and a third antenna pattern in which a single horizontal conductor for forming the third antenna pattern having a different power feed point than that of the first and second antenna patterns is disposed in the vicinity of the antifogging heater.

Preferably, an antifogging heater capacitively coupled with the second antenna pattern is formed in the lower part of the first antenna pattern, and a diversity antenna is formed by the first and second antenna patterns and the antifogging heater.

Preferably, the surface area of the first antenna pattern formed on the glass surface is expanded and disposed without changing the antenna length of the horizontal conductors included in the first antenna pattern and to an extent that does not affect the receiving performance of the second antenna pattern.

### Advantageous Effects of Invention

In accordance with the glass antenna according to the present invention, independently provided first and second antenna patterns having different receiving bands are connected by a connecting conductive line. Therefore, terminals and input lines required for each become unnecessary, and it is consequently possible to reduce the number of components and to reduce the labor required for assembly and adjustment.

Also, the effect on the receiving sensitivity before and after connecting the connecting conductive line is slight, and it is possible to obtain a shared antenna pattern without using considerable time to make adjustments, as is the case with a conventional shared antenna pattern.

Also, in accordance with the glass antenna of the present invention, it is possible to make slight adjustments to the receiving sensitivity using a receiving-sensitivity adjustment element after the first antenna pattern and the second antenna pattern have been connected by the connecting conductive line. Therefore, the adjustment work can be made flexible and extendible, and convenience can be provided to the worker.

Furthermore, a diversity antenna can be built in a simple manner using the first and second antenna patterns, and the third antenna pattern. Therefore, reception quality can be improved because antenna signals in an excellent radio-wave state can be used preferentially.

### DESCRIPTION OF EMBODIMENTS

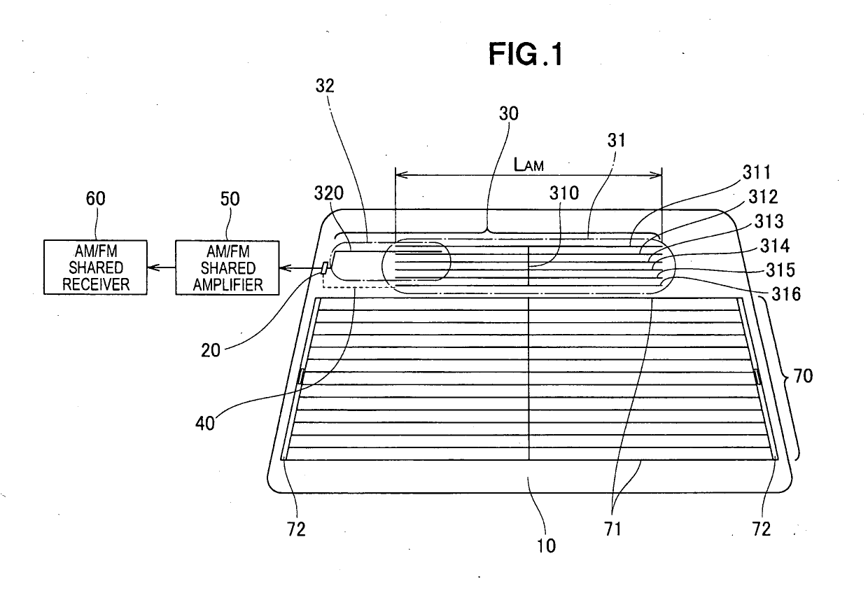

FIG. 1 is diagram showing an example of an antenna pattern of the glass antenna according to a first embodiment of the present invention;

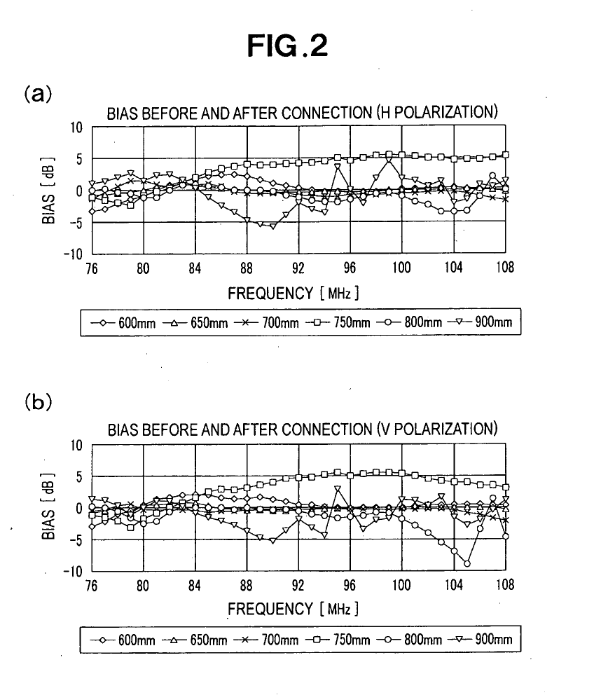

FIG. 2 is a diagram in the form of an evaluation graph showing the bias of receiving sensitivity in the FM band before and after adding a connecting conductive line in the glass antenna shown in FIG. 1;

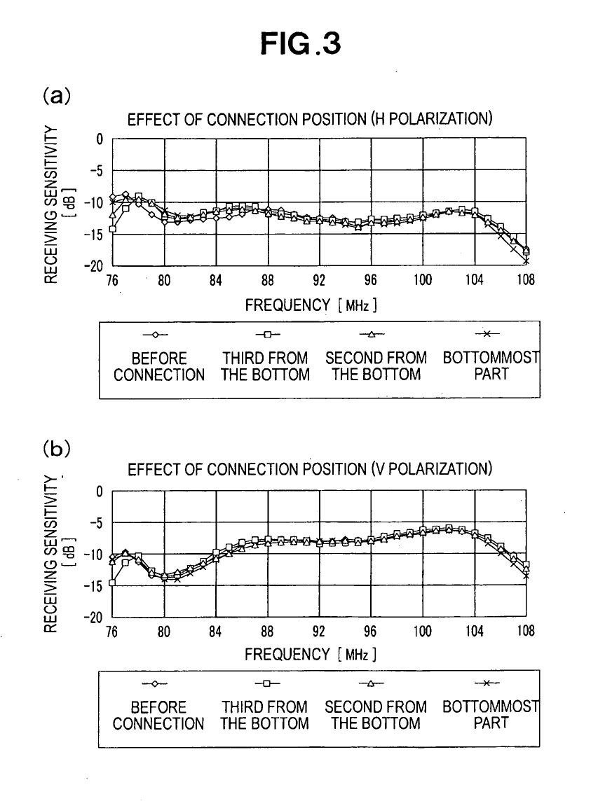

FIG. 3 is a diagram in the form of an evaluation graph showing the receiving sensitivity in the FM band when the connection position of the connecting conductive line has been varied in the glass antenna shown in FIG. 1;

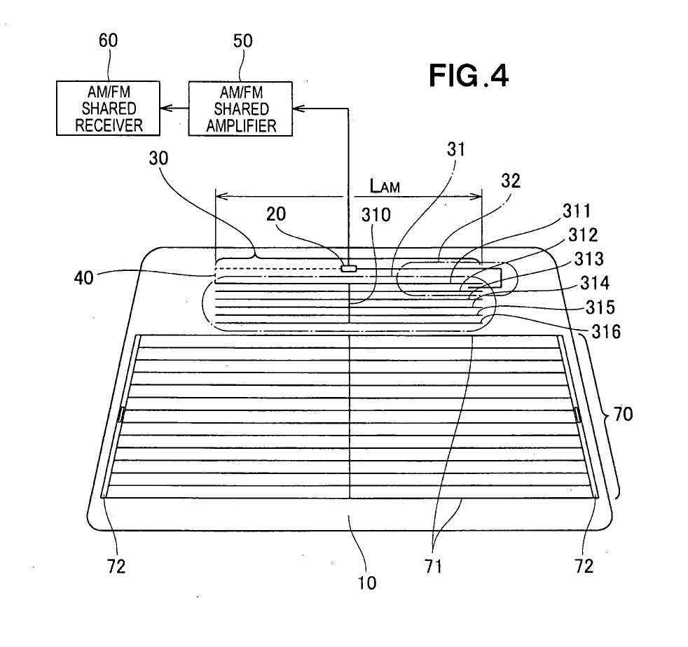

FIG. 4 is a diagram of a modified example of the antenna pattern of the glass antenna according to the first embodiment of the present invention;

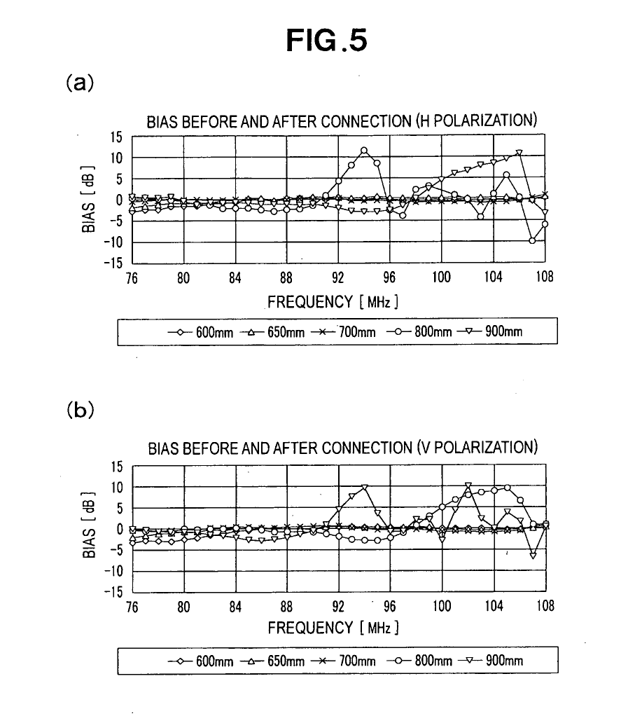

FIG. 5 is a diagram in the form of an evaluation graph showing the bias of receiving sensitivity in the FM band before and after adding a connecting conductive line in the glass antenna shown in FIG. 4;

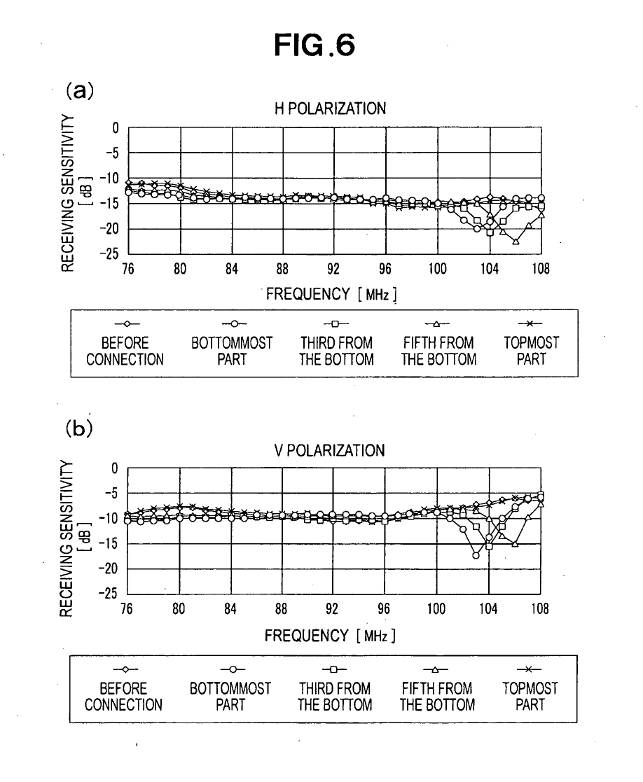

FIG. 6 is a diagram in the form of an evaluation graph showing the receiving sensitivity in the FM band when the connection position of the connecting conductive line has been varied in the glass antenna shown in FIG. 4;

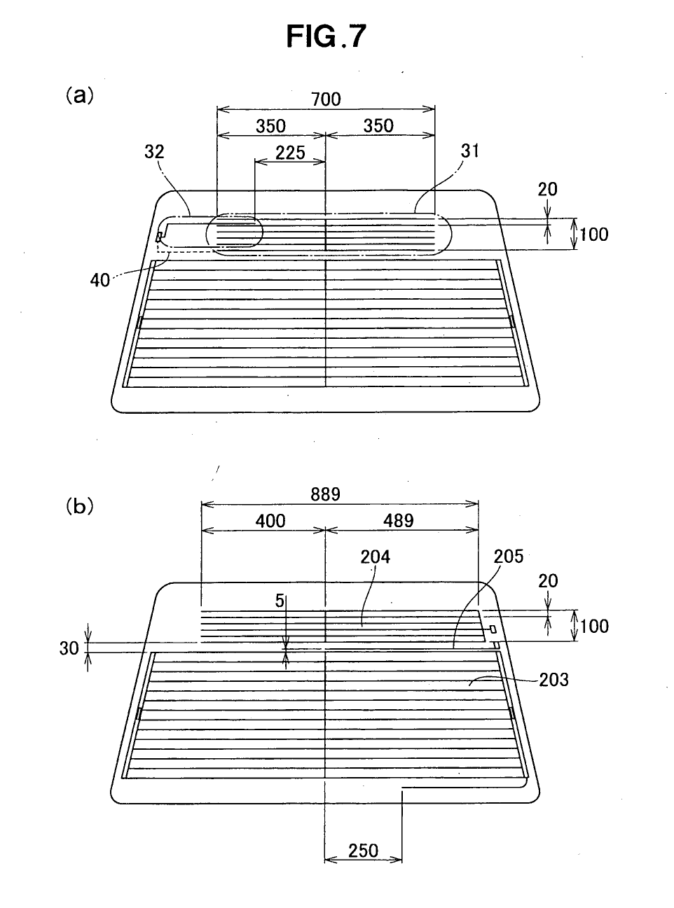

FIG. 7 is a diagram showing a comparison of the size of the glass antenna according to the first embodiment of the present invention and the size of a conventional glass antenna;

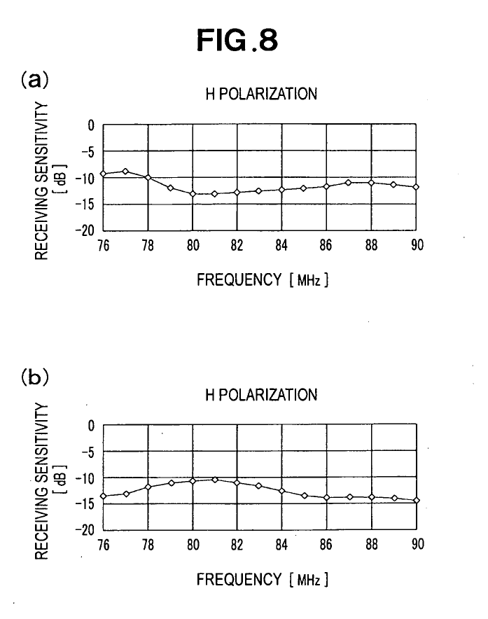

FIG. 8 is a diagram showing a comparison of the receiving sensitivity of the glass antenna according to the first embodiment of the present invention and the receiving sensitivity of a conventional glass antenna;

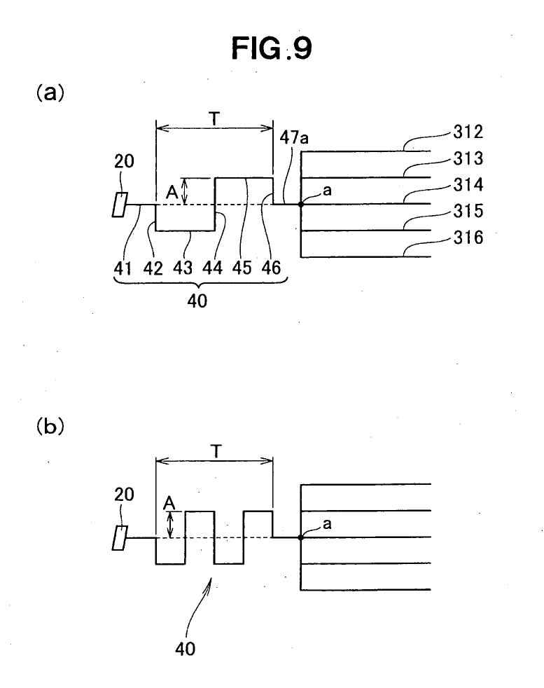

FIG. 9 is a diagram showing an example of a mounting pattern of the connecting conductive line in FIG. 1;

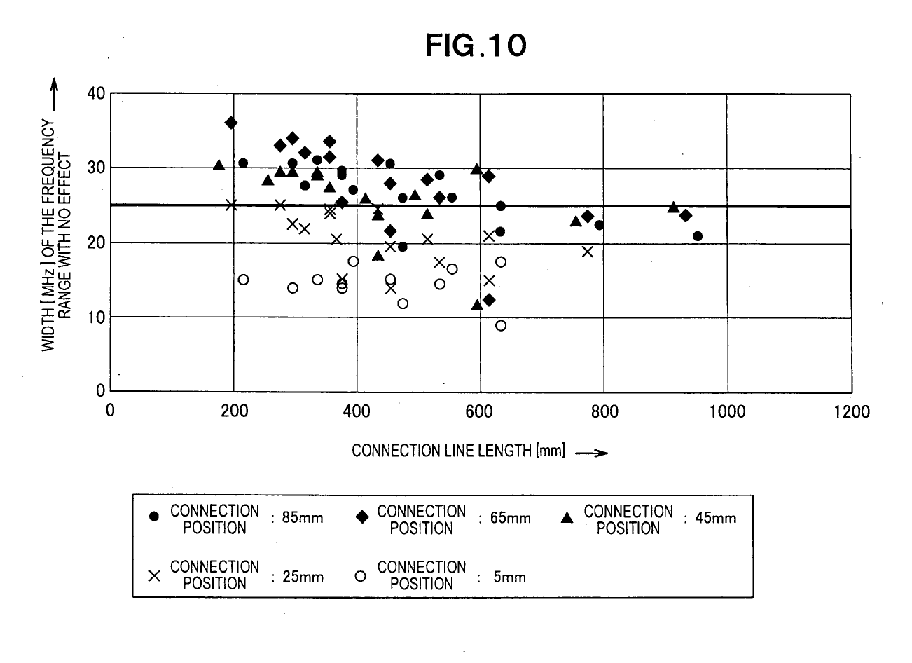

FIG. 10 is a graph showing the optimal connection position of the connecting conductive line in FIG. 1, and the relationship between the length of the connecting line and the receiving frequency range.

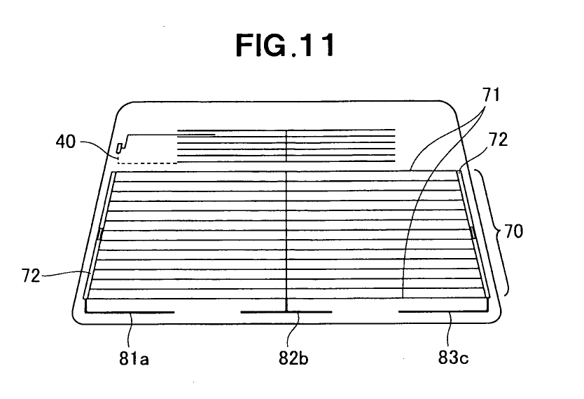

FIG. 11 is a diagram showing an antenna pattern of the glass antenna according to the second embodiment of the present invention;

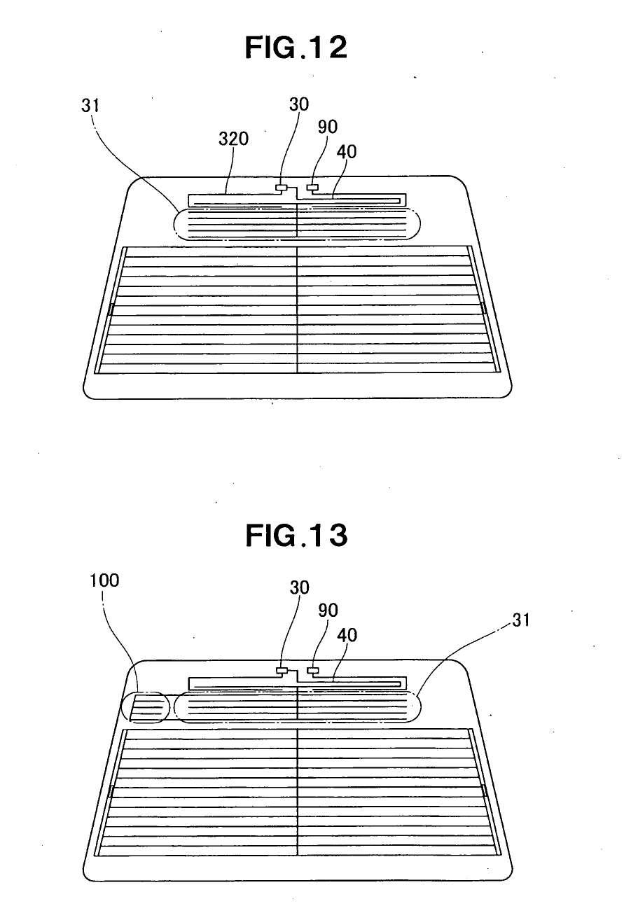

FIG. 12 is a diagram showing an antenna pattern of the glass antenna according to the third embodiment of the present invention;

FIG. 13 is a diagram showing an antenna pattern of the glass antenna according to the fourth example of the present invention;

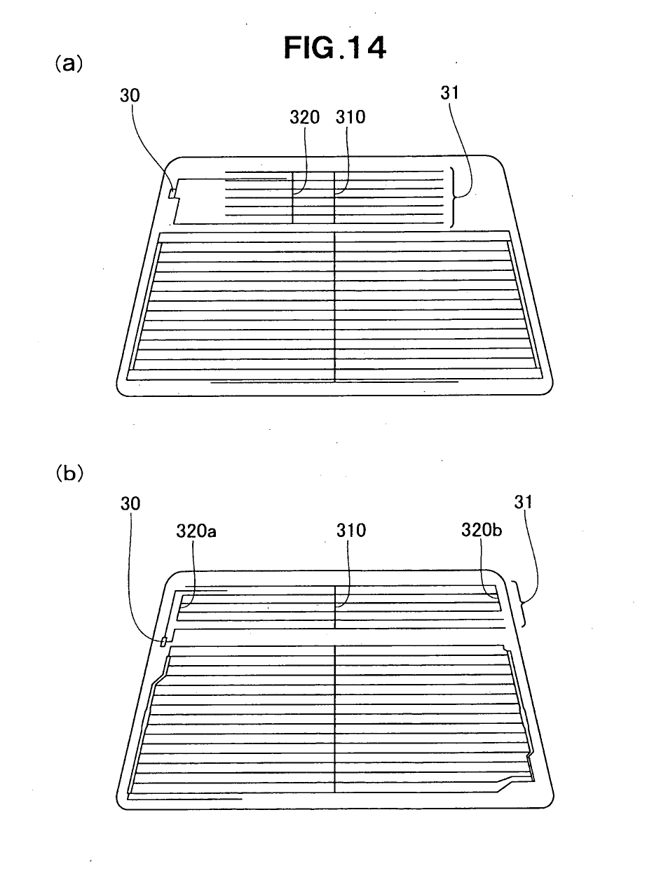

FIG. 14 is a diagram showing an antenna pattern of the glass antenna according to the fifth embodiment of the present invention;

FIG. 15 is a diagram showing an example of the configuration of a conventional glass antenna; and

FIG. 16 is a diagram showing another example of the configuration of a conventional glass antenna.

### DESCRIPTION OF EMBODIMENTS

The design concept of a glass antenna of the present invention will be described in a simple manner prior to a description of the embodiments. The glass antenna of the present invention is characterized in that, e.g., an AM antenna and an FM antenna are adjusted as independent antenna patterns, and the AM antenna and the FM antenna are thereafter joined together with the addition of a connecting conductive line to obtain an AM/FM shared antenna pattern.

The effect on the receiving sensitivity of the antenna patterns is slight before and after adding the connecting conductive line described above, and it is possible to obtain an AM/FM shared antenna pattern without using considerable time to make adjustments in comparison with the complicated conventional AM/FM shared antenna pattern. The details thereof are described below in each example.

First, the first embodiment will be described with reference to FIGS. 1 to 6.

FIG. 1 is diagram showing an antenna pattern of the glass antenna according to the first embodiment, and in this case, illustrates an antenna pattern having a lateral-edge power feed.

### Embodiment 1

In FIG. 1, a rear glass 10 is the glass surface of the rear window of a vehicle. A power feed point 20 is formed on the rear glass 10, feeds power to later-described antenna patterns, and is formed in the lateral-edge corner part of the rear glass 10 (lateral-edge power feed).

An AM/FM shared antenna 30 includes an AM antenna 31 (first antenna pattern) for receiving mainly an AM band, and an FM antenna 32 (second antenna pattern) for receiving mainly an FM band.

The AM antenna pattern 31 is composed of a single vertical conductor 310 extending in the perpendicular direction substantially in the center of the rear glass 10, and six horizontal conductors 311 to 316 orthogonal to the vertical conductor 310 and extending to the left and right in intervals of about 20 mm.

The FM antenna pattern 32 is composed of a single horizontal conductor 320 disposed so as to be capacitively coupled with the AM antenna pattern 31.

The connecting conductive line 40 is drawn with a dotted line. The connecting conductive line 40 connects the power feed point 20 and a single discretionary horizontal conductor (in this case, horizontal conductor 316) among the plurality of horizontal conductors 311 to 316 constituting the AM antenna pattern 31. Hereinbelow, any of the horizontal conductors 311 to 316 connected to the power feed point 20 are referred to as a basic AM antenna pattern.

An AM/FM shared amplifier 50 (shared amplifier) is connected to the power feed point 20, and the AM/FM shared amplifier 50 amplifies and feeds a signal received by the AM/FM shared antenna 30 to the AM/FM shared receiver 60.

An electric heating-type antifogging heater 70 is formed in the lower part of the AM/FM shared antenna 30, and the electric heating-type antifogging heater 70 is composed of a plurality of heater lines 71 and a bus bar 72 for energizing the heater lines 71.

The horizontal conductors 311 to 316 constituting the AM antenna pattern 31 described above are 350 mm or less in length left and right (antenna length LAM: 700 mm) from the center of the rear glass (the vertical conductor 310), and a length of 325 mm to 350 mm is particularly preferred.

The reason for the above is described below with reference to the evaluation graph shown in FIG. 2. FIG. 2 is a diagram in the form of a graph showing the bias of receiving sensitivity in the FM band before and after adding a connecting conductive if line in the glass antenna of the first embodiment, wherein FIG. 2(a) shows H polarization and FIG. 2(b) shows V polarization.

FIGS. 2(a) and 2(b) both show bias [dB] in relation to the frequency f [MHz] in the FM band when the antenna length LAM is 600 mm, 650 mm, 700 mm, 800 mm, and 900 mm.

It is apparent that in order to minimize the effect on receiving sensitivity of adding the connecting conductive line 40 in the case of lateral-edge power feed, the best case is an antenna length LAM of 700 mm (350 mm to the left and right) in which there is substantially no fluctuation in the receiving sensitivity even when the frequency changes, as shown in FIGS. 2(a) and 2(b).

It is advantageous to have the horizontal conductor 320 constituting the FM antenna pattern 32 be disposed between the horizontal conductor 311 (first line) positioned in the upper part or the topmost part of the AM antenna pattern 31 and the horizontal conductor 322 (second line) positioned therebelow.

In the case of lateral-edge power feed, as shown in FIG. 1, it is advantageous to have the connecting conductive line 40 be connected to the horizontal conductor 316 positioned in the bottommost part of the AM antenna pattern 31 for the Japanese market, and to the horizontal conductor 314 positioned third from the bottom for the North American market.

The reason for the above is described below with reference to the evaluation graph shown in FIG. 3. FIG. 3 is a diagram in the form of graph showing the receiving sensitivity in the FM band when the connection position of the connecting conductive line 40 has been varied, wherein FIG. 3(a) shows H polarization and FIG. 3(b) shows V polarization.

FIGS. 3(a) and 3(b) both show the receiving sensitivity prior to connection of the connecting conductive line 40; and for the cases in which the connecting conductive line 40 has been connected to the third horizontal conductor (horizontal conductor 314) from the bottom of the AM antenna pattern 31, to the second horizontal conductor (horizontal conductor 315) from the bottom, and to the bottommost horizontal conductor (horizontal conductor 316).

It is apparent that it is optimal for a glass antenna destined for the Japanese market, which uses 76 MHz to 90 MHz, to have the connecting conductive line 40 connected to the horizontal conductor 316 positioned in the bottommost horizontal conductor among the horizontal conductors 311 to 316 constituting the AM antenna pattern 31, and for a glass antenna destined for the North American market, which uses 88 MHz to 108 MHz, to have the connecting conductive line 40 connected to the horizontal conductor 314 positioned third from the bottom, because the resulting sensitivity is maximized, as shown in FIGS. 3(a) and 3(b).

FIG. 4 is a diagram of a modified example of the antenna pattern of the glass antenna according to the first embodiment of the present invention, and in this case shows the antenna pattern of a upper-edge power feed.

In the case of the upper-edge power feed described below, there is a difference the lateral-edge power feed shown in FIG. 1 and the formation of the power feed point 20 formed on the upper edge and substantially center part of the rear glass 10, and since the antenna pattern is the same as the case of the lateral-edge power feed, a description is omitted to avoid redundant description.

However, in the case of an upper-edge power feed, it is advantageous for the connecting conductive line 40 to be connected to the horizontal conductor 311 positioned in the topmost part of the AM antenna pattern 31, which is positioned on the side opposite from the side in which the horizontal conductor 320 of the FM antenna pattern 32 is disposed.

The reason for the above is described below with reference to the evaluation graph shown in FIGS. 5 and 6. FIG. 5 is a diagram showing the bias of receiving sensitivity in the FM band before and after connecting the connecting conductive line 40, wherein FIG. 5(a) shows H polarization and FIG. 5(b) shows V polarization. FIG. 6 is a diagram showing the receiving sensitivity in the FM band when the connection position of the connecting conductive line 40 has been varied, wherein FIG. 6(a) shows H polarization and FIG. 6(b) shows V polarization.

It is apparent that in the case of the upper-edge power feed as well, bias is low and optimal when the antenna length LAM is made to be 700 mm (350 mm left and right) or less, as shown in FIGS. 5(a) and 5(b), in the same manner as the lateral-edge power feed described in the first embodiment.

It is optimal for the connecting conductive line 40 to be connected to the horizontal conductor 311 positioned at the topmost part among the horizontal conductors 311 to 316 constituting the AM antenna pattern 31, as shown in FIGS. 6(a) and 6(b). When the connecting conductive line 40 is connected in a position other than the topmost part, a frequency is generated in which receiving sensitivity in the FM band varies inordinately. In contrast, when the connection is the topmost position, frequency characteristics are changed, but it is possible to adapt by adjusting the size of the horizontal conductor 320 constituting the FM antenna pattern 32.

The differences between the first embodiment described above and the prior art example disclosed in Patent Literature 2 will be discussed below in terms of antenna size and characteristics.

The inventors manufactured and mounted in a vehicle an antenna pattern of a glass antenna designed on the basis of the design concepts described above, and an antenna pattern of a glass antenna designed on the basis of the technical concepts disclosed in Patent Literature 2, and then made a comparative evaluation of the performance of the vehicle placed in an anechoic chamber. In an anechoic chamber, electromagnetic waves are radiated from a single direction while the vehicle is rotated 360 degrees, the receiving sensitivity is measured in each direction of the vehicle, and characteristic values of the receiving sensitivity for the entire periphery are obtained. The receiving characteristics and the size of the glass antenna used at that time are shown by comparison in FIGS. 7 and 8.

FIG. 7(a) is a dimensional diagram of each part including the antenna length of the glass antenna manufactured on the basis of the design concepts of the glass antenna according to the first embodiment; and FIG. 7(b) is a dimensional diagram of each part including the antenna length of the glass antenna manufactured on the basis of the technical concepts disclosed in Patent Literature 2.

In the first embodiment, the antenna length is 700 mm, the FM antenna pattern 32 is disposed between the horizontal conductors constituting the AM antenna pattern 31, and an AM/FM antenna pattern is formed with the aid of the connecting conductive line 40, as shown in FIG. 7(a). In contrast, there are considerable differences with the antenna pattern designed on the basis of the technical concepts disclosed in Patent Literature 2 in that the antenna length is 889 mm, the FM antenna 205 is disposed in the vicinity of the anti-fogging heater 203, and power is fed independently from the AM antenna 204.

FIG. 8(a) is a graph of the receiving sensitivity characteristics of the FM band (H band) of the glass antenna of the first embodiment destined for the Japanese market; and FIG. 8(b) is a graph of the receiving sensitivity characteristics of the FM band (H band) of the prior art example destined for the Japanese market.

It is apparent from the graphs of the receiving sensitivity characteristics of FIGS. 8(a) and 8(b) that the glass antenna according to the first embodiment obtains substantially the same receiving sensitivity characteristics as those of the antenna pattern designed on the basis of the technical concepts disclosed in Patent Literature 2.

In other words, according to the art disclosed in Patent Literature 2, the FM antenna 205 is provided between the anti-fogging heater 203 and the AM antenna 204 and independently from the AM antenna 204. Therefore, terminals are required for each component, and input lines to the amplifier are required in accompaniment therewith. In contrast, in the first embodiment, an AM/FM antenna pattern is formed with the aid of the connecting conductive line 40, whereby the same performance as that of the art disclosed in Patent Literature 2 can be successfully obtained even though the number of terminals and input lines has been reduced.

In the case of a peripheral-edge power feed, the connection position between the connecting conductive line 40 and the AM antenna pattern 31 (basic AM antenna pattern) is preferably a position set at a distance of 45 mm or more from the FM antenna pattern 32. Also, the line length is preferably 400 mm or less.

The reason for the above is described below.

The inventors tested receiving performance by varying the connection position and the connection line length in accordance with the following conditions in order to further clarify the connection conditions of the connecting conductive line 40 that are suitable for the AM/FM shared antenna 30.

Here, a test was carried out in relation to a wiring layout for the case in which the AM antenna pattern 31 was disposed substantially in the center of the upper part of the anti-fogging heater 203, as shown in FIG. 1, and for the case in which the AM antenna pattern 31 was disposed 100 mm to the right from substantially the center of the upper part of the anti-fogging heater 203.

In either of the layouts described above, six horizontal conductors (horizontal conductors 311 to 316) constituting the AM antenna pattern 31 were disposed at intervals of 20 mm, in the same manner as FIG. 1, and the connecting conductive line 40 was connected to the basic AM antenna pattern. Here, the FM antenna pattern 32 was disposed between the horizontal conductor 311 of the topmost part of the AM antenna pattern 31 and the horizontal conductor 312 positioned therebelow. Therefore, the horizontal conductor 311 of the topmost part was excluded from the basic AM antenna pattern connected to the power feed point 20.

Therefore, the interval between the FM antenna pattern 32 and the horizontal conductors 312 to 316 as a basic AM antenna pattern was sequentially varied by 85 mm, 65 mm, 45 mm, 25 mm, and 5 mm from the bottommost horizontal conductor 316 (first row) toward the horizontal conductor 312 (fifth row) positioned below the topmost horizontal conductor 311

The connecting conductive line 40 was varied in line length by mounting pattern.

For example, the mounting pattern of the connecting conductive line 40 extending from the power feed point 20 toward the connection location a of the basic AM antenna pattern (horizontal conductors 312 to 316) was a crank shape or a serpentine shape, as shown in FIG. 9(a).

Specifically, in the example shown in FIG. 9(a), the connecting conductive line 40 was composed of a first line 41 extending horizontally from the power feed point 20 toward the connection location a; a second line 42 extending in the downward direction at a right angle from the end of the first line 41; a third line 43 extending at a right angle from the end of the second line 42, and in the horizontal direction parallel to the first line toward the connection location a; a fourth line 44 extending at a right angle from the end of the third line 43, and in the upward direction parallel to the second line; a fifth line 45 extending at a right angle from the end of the fourth line 44, and in the horizontal direction parallel to the third line 43 toward the connection location a; a sixth line 46 extending at a right angle from the end of the fifth line 45, and in the downward direction parallel to the fourth line; and a seventh line 47 extending at a right angle from the end of the sixth line 46, and in the horizontal direction parallel to the fifth line 45 toward the connection location a to connect to the connection point a.

A is the distance between the extension line expressed as a dotted line parallel to the fifth line extending toward the connection location a, and between the power feed point 20 and the connection location a; T is the distance in the horizontal direction between the second line and the sixth line; and N is the number of repetitions of the pattern in the horizontal direction shown between the second line and the sixth line.

The example shown in FIG. 9(b) has a dense crank shape or serpentine shape in which T is not varied and N is doubled. Thus, A was made to fluctuate in a range of 0 to 40 mm, and N was made to fluctuate in a range of 0 to 4 repetitions. The purpose for this was to measure the effect on the receiving sensitivity of the FM antenna pattern 32.

In other words, an attempt was made to vary the connection position and the length of the connection line using the conditions summarized in the following table to find the conditions for connecting the connecting conductive line 40 that are suitable for the AM/FM shared antenna 30, using a wiring layout for the case in which the AM antenna pattern 31 is disposed substantially in the center of the upper part of the anti-fogging heater 203.

TABLE 1

| | | | Connecting line length |
|---|---|---|---|
| A | N | Connection position | [mm] |
| 0 | 0 | First row | 215 |
| | | Second row | 195 |
| | | Third row | 175 |
| | | Fourth row | 195 |
| | | Fifth row | 215 |
| 20 | 1 | First row | 295 |
| | | Second row | 275 |
| | | Third row | 255 |
| | | Fourth row | 275 |
| | | Fifth row | 295 |
| | 1.5 | First row | 335 |
| | | Second row | 315 |
| | | Third row | 295 |
| | | Fourth row | 315 |
| | | Fifth row | 335 |
| | 2 | First row | 375 |
| | | Second row | 355 |
| | | Third row | 335 |
| | | Fourth row | 355 |
| | | Fifth row | 375 |
| 40 | 1 | First row | 375 |
| | | Second row | 355 |
| | | Third row | 335 |
| | | Fourth row | 355 |
| | | Fifth row | 375 |
| | 1.5 | First row | 455 |
| | | Second row | 435 |
| | | Third row | 415 |
| | | Fourth row | 435 |
| | | Fifth row | 455 |
| | 2 | First row | 535 |
| | | Second row | 515 |
| | | Third row | 495 |
| | | Fourth row | 515 |
| | | Fifth row | 535 |

Also, an attempt was made to vary the connection position and the length of the connection line using the conditions summarized in the following table, and to find conditions for connecting the connecting conductive line 40 that are suitable for the AM/FM shared antenna 30, using a wiring layout for the case in which the AM antenna pattern 31 is disposed in a position displaced 100 mm to the right from substantially the center of the upper part of the anti-fogging heater 203.

TABLE 2

| | | | Connecting line length |
|---|---|---|---|
| A | N | Connection position | [mm] |
| 0 | 0 | First row | 315 |
| | | Second row | 295 |
| | | Third row | 275 |
| | | Fourth row | 295 |
| | | Fifth row | 315 |
| 20 | 1 | First row | 395 |
| | | Second row | 375 |
| | | Third row | 355 |
| | | Fourth row | 375 |
| | | Fifth row | 395 |
| | 2 | First row | 475 |
| | | Second row | 455 |
| | | Third row | 435 |
| | | Fourth row | 455 |
| | | Fifth row | 475 |
| | 3 | First row | 555 |
| | | Second row | 535 |
| | | Third row | 515 |
| | | Fourth row | 535 |
| | | Fifth row | 555 |
| | 4 | First row | 635 |
| | | Second row | 615 |
| | | Third row | 595 |
| | | Fourth row | 615 |
| | | Fifth row | 635 |
| 40 | 1 | First row | 475 |
| | | Second row | 455 |
| | | Third row | 435 |
| | | Fourth row | 455 |
| | | Fifth row | 475 |
| | 2 | First row | 635 |
| | | Second row | 615 |
| | | Third row | 595 |
| | | Fourth row | 615 |
| | | Fifth row | 635 |
| | 3 | First row | 795 |
| | | Second row | 775 |
| | | Third row | 755 |
| | | Fourth row | 775 |
| | | Fifth row | 795 |
| | 4 | First row | 955 |
| | | Second row | 935 |
| | | Third row | 915 |
| | | Fourth row | 935 |
| | | Fifth row | 955 |

The test results are described below. The FM radio band for Japan is 76 to 90 MHz, the FM radio band for North America is 88 to 108 MHz, and there is a need to achieve a frequency value of 25 MHz in which the characteristics do not vary before and after connection as the required conditions for receiving such bands.

The relationship between the connection position and the connection length of the connecting conductive line 40 that will satisfy this need is shown in the graph in FIG. 10. The solid bold line shown in the graph is 25 MHz, the required value of the frequency in which the characteristics do not vary before and after connection as the required condition for reception.

It is apparent from the graph of FIG. 10 that in order to obtain the required value 25 MHz, the connecting conductive line 40 is positioned 45 mm or more away from the FM antenna pattern 32, and the connection length is 400 mm or less.

As described above, in accordance with the glass antenna of the first embodiment of the present invention, a single discretionary horizontal conductor among the plurality of horizontal conductors 311 to 316 of the AM antenna pattern 31 is connected to the power feed point 20 by the connecting conductive line 40, whereby the AM antenna pattern 31 and the FM antenna pattern 32 can be used as an AM/FM shared antenna pattern.

At this time, the effect on the receiving sensitivity before and after connecting the connecting conductive line 40 is slight, and it is possible to provide a high performance AM/FM antenna without an increase in the number of components. Adjustment is facilitated because the AM antenna pattern 31 and the FM antenna pattern 32 can be adjusted independently prior to connecting the connecting conductive line 40, and labor required for adjustment can be reduced.

### Second Embodiment

Next, a second embodiment will be described with reference to FIG. 11.

FIG. 11 is a diagram showing the antenna pattern of the glass antenna according to the second embodiment.

As shown in FIG. 11, the glass antenna according the second embodiment has receiving-sensitivity adjustment elements 81a, 81b, 81c connected to the heater lines 71 or to a portion of the bus bar 72 constituting the antifogging heater 70 in the lateral-edge power-feed antenna pattern of the first embodiment shown in FIG. 1. The receiving-sensitivity adjustment elements 81a, 81b, 81c may be any number and shape as long as they are connected to a portion of the antifogging heater 70 and the antifogging heater 70 (heater lines 71) acts as a portion of the antenna.

In accordance with the glass antenna according to the second embodiment described above and in addition to the effects provided by the first embodiment, the adjustment work can be made flexible and extendible, and convenience can be provided to the worker because the receiving sensitivity can be finely adjusted using the receiving-sensitivity adjustment elements 81a, 81b, 81c after the AM antenna pattern 31 and the AM antenna pattern 31 have been connected by the connecting conductive line 40 to form an AM/FM antenna pattern.

### Third Embodiment

Next, a third embodiment will be described with reference to FIG. 12.

FIG. 12 is a diagram showing the antenna pattern of the glass antenna according to the third embodiment.

As shown in FIG. 12, the glass antenna according the third embodiment has an FM sub-antenna 90 added to the antenna pattern of the upper-edge power feed of the first embodiment shown in FIG. 4.

The FM sub-antenna 90 is capacitively coupled with the AM antenna pattern 31 in the same manner as the horizontal conductor 320 of the FM antenna pattern 32 constituting the AM/FM shared antenna 30. As shown in FIG. 12, the FM sub-antenna 90 may be provided in the vicinity of the antifogging heater 70 and is not required to be formed between the horizontal conductors 311 and 312 constituting the AM antenna pattern 31; and may also be obtained by capacitively coupling the antifogging heater 70 with the horizontal conductor 320 constituting the FM antenna pattern 32 of the AM/FM shared antenna 30.

In accordance with the glass antenna according to the third embodiment described above and in addition to the effects provided by the first embodiment, it is possible to form an FM diversity antenna from the AM/FM shared antenna 30 and the FM sub-antenna 90, and the receiving quality is improved because antenna signals in an excellent radio-wave state can be used preferentially.

### Fourth Embodiment

Next, a fourth embodiment will be described with reference to FIG. 13.

FIG. 13 is a diagram showing the antenna pattern of the glass antenna according to the fourth embodiment.

As shown in FIG. 13, the glass antenna according to the fourth embodiment has an antenna pattern 100 for improving AM receiving sensitivity added to the antenna pattern of the upper-edge power feed of the first embodiment shown in FIG. 4. It is widely known that AM receiving sensitivity depends on the surface area of the AM antenna pattern 31. Therefore, in the fourth embodiment, an antenna was designed based on the design concepts of the present invention, and an antenna pattern 100 for improving AM receiving sensitivity and that has little effect on FM receiving performance was added thereafter.

In this case, the antenna pattern 100 for improving AM receiving sensitivity has the first line (horizontal conductor 311) and the sixth line (horizontal conductor 316) constituting the AM antenna pattern connected in a sideward-U shape extending in the direction of blank space of the rear glass 10, and the total surface area of the AM antenna pattern 31 is increased.

The shape of the antenna pattern 100 for improving AM receiving sensitivity is not limited to the shape shown in FIG. 13, and may be a discretionary shape in a range that does not affect the receiving performance of the FM antenna pattern 32 and in which the antenna length of the horizontal conductors included in the AM antenna pattern 31 is not changed.

In accordance with the glass antenna according to the fourth embodiment described above and in addition to the effects provided by the first embodiment, AM receiving performance can be improved by expanding and arranging the surface area of the AM antenna pattern 31 formed on the rear glass 10 by an amount that does not affect the receiving performance of the FM antenna pattern and in which the antenna length of the horizontal conductors included in the AM antenna pattern is not changed.

### Fifth Embodiment

Next, a fifth embodiment will be described with reference to FIGS. 14(a) and 14(b).

FIG. 14(a) is a diagram showing the antenna pattern of the glass antenna according to the fifth embodiment; and FIG. 14(b) is a diagram showing a modified example thereof.

As shown in FIG. 14(a), the antenna pattern according to the fifth embodiment has an additional element 320, which is a single vertical conductor parallel to and set at a predetermined distance from the vertical conductor 310, separate from the single vertical conductor 310 extending in the vertical direction in substantially the center of the rear glass 10 in the lateral-edge power-feed antenna pattern of the first embodiment shown in FIG. 1. In this case, the horizontal conductors 311 to 316 of the AM/FM shared antenna 30 are extended in the mounting direction of the power feed point 20 orthogonal to the additional element 320. The additional element 320 is used for adjusting the receiving sensitivity of the FM band when tuning (adjusting) is carried out.

As shown in FIG. 14(b), it is also possible to add to the horizontal conductors 311 to 316 vertical conductors 320a, 320b that are separate from the single vertical conductor 310 extending in vertical direction in substantially the center of the rear glass 10.

In accordance with the glass antenna according to the fifth embodiment described above, the adjustment work can be made flexible and extendible, and convenience can be provided to the worker because FM receiving sensitivity can be finely adjusted using the added vertical conductor 310 (or 310a, 310b). Also, after tuning the AM antenna pattern 31, which is carried out independently from the above, the AM antenna pattern 31 and the FM antenna pattern 32 are connected by the connecting conductive line 40 and are thereby joined as an AM/FM shared antenna pattern.

### INDUSTRIAL APPLICABILITY

The glass antenna of the present invention obtains dramatic effect in application to vehicle window glass, and rear glass in particular. In examples 1 to 4 described above, only examples in which the AM antenna pattern 31 and the FM antenna pattern 32 are used as an AM/FM shared antenna pattern were described. However, this is not limited to AM and FM, and application can also be made to glass antennas that share two or more antenna patterns having different receiving bands. The cost-reduction trend for automotive components is steadily increasing, and the effect obtained by the present invention is considerable in the midst of the need to further reduce costs for antennas as well.

### REFERENCE SIGNS LIST

10: rear glass (glass surface), 20: power feed point, 30: AM/FM shared antenna, 31: AM antenna pattern (first antenna pattern), 32: FM antenna pattern (second antenna pattern), 310: vertical conductor, 311 to 316: horizontal conductors, 320: horizontal conductor, 40: connecting conductive line, 50: AM/FM shared amplifier (shared amplifier), 60: AM/FM receiver, 70: antifogging heater, 71: heater line, 72: bus bar, 81a, 81b, 81c: receiving-sensitivity adjustment elements, 90: FM sub-antenna, 100: antenna pattern for improving AM receiving sensitivity

1. A glass antenna having an antenna pattern and a power feed point for feeding power to the antenna pattern formed on a glass surface, comprising:
a first antenna pattern having at least one vertical conductor and a plurality of horizontal conductors made orthogonal to the vertical conductor;
a second antenna pattern comprised of a single, mainly horizontal conductor capacitively coupled with the first antenna pattern, the second antenna pattern having one end connected to the power feed point and having a receiving frequency band different from that of the first antenna;
a connecting conductive line for connecting a single discretionary line among the horizontal conductors of the first antenna pattern to the power feed point; and
a shared amplifier for amplifying a signal received by the first antenna pattern and the second antenna pattern, the shared amplifier being connected to the power feed point.

2. The glass antenna of claim 1, wherein the horizontal conductors of the first antenna pattern extend 325 to 350 mm from the vertical conductor.

3. The glass antenna of claim 1, wherein the horizontal conductor of the second antenna pattern is disposed in an upper part of a first line of a topmost part among the plurality of horizontal conductors of the first antenna pattern.

4. The glass antenna of claim 1, wherein the horizontal conductor of the second antenna pattern is disposed between the first line of the topmost part and a second line therebelow among the plurality of horizontal conductors of the first antenna pattern

5. The glass antenna of claim 1, wherein the power feed point is a lateral-edge power feed point formed on the lateral-edge corner part of the glass surface, and the connecting conductive line is connected to the horizontal conductor formed in a bottommost part of the first antenna pattern.

6. The glass antenna of claim 1, wherein the power feed point is a lateral-edge power feed point formed on the lateral-edge corner part of the glass surface, and the connecting conductive line is connected to the third horizontal conductor from the bottom among the horizontal conductors of the first antenna pattern.

7. The glass antenna of claim 1, wherein the power feed point is a lateral-edge power feed point formed on the lateral-edge corner part of the glass surface, and the connecting conductive line has a length of 400 mm or less and is connected in a position 45 mm or more away from the second antenna pattern.

8. The glass antenna of claim 1, wherein the power feed point is an upper-edge power feed point formed on the upper edge and substantially center part of the glass surface, and the connecting conductive line is connected to a topmost first line of the first antenna pattern positioned on the side opposite from the side on which the horizontal conductor of the second antenna pattern is disposed, using the line perpendicular to the glass surface through which the power feed point passes as a boundary.

9. The glass antenna of claim 1, wherein an antifogging heater formed in the lower part of the first antenna pattern, and a receiving-sensitivity adjustment element for adjusting the receiving sensitivity of the first antenna pattern and the second antenna pattern, the receiving-sensitivity adjustment element being connected to at least one of a bus bar and a heater line included in the antifogging heater.

10. The glass antenna of claim 1, wherein a single horizontal conductor for forming a third antenna pattern having a different power feed point than that of the first and second antenna patterns is disposed on the side opposite from the side on which the horizontal conductor forming the second antenna pattern is disposed, using the vertical conductor of the first antenna pattern as a boundary, and a diversity antenna is formed by the first and second antenna patterns and the single horizontal conductor for forming the third antenna pattern.

11. The glass antenna of claim 1, wherein a diversity antenna is formed by: an antifogging heater formed in the lower part of the first antenna pattern; the first and second antenna patterns; and a third antenna pattern in which a single horizontal conductor for forming the third antenna pattern having a different power feed point than that of the first and second antenna patterns is disposed in the vicinity of the antifogging heater.

12. The glass antenna of claim 1, wherein an antifogging heater capacitively coupled with the second antenna pattern is formed in the lower part of the first antenna pattern, and a diversity antenna is formed by the first and second antenna patterns and the antifogging heater.

13. The glass antenna of claim 1, wherein the surface area of the first antenna pattern formed on the glass surface is expanded and disposed without changing the antenna length of the horizontal conductors included in the first antenna pattern and to an extent that does not affect the receiving performance of the second antenna pattern.
